(19) United States
(12) Patent Application Publication
(10) Pub. No.: US 2020/0169924 A1
(43) Pub. Date: May 28, 2020

(54) SERVICE CONTINUITY IN CASE OF NOMADIC RELAY'S SUDDEN SHUT-OFF

(71) Applicant: NOKIA TECHNOLOGIES OY, Espoo (FI)

(72) Inventors: Andreas LOBINGER, Grafing (DE); Bernhard WEGMANN, Holzkirchen (DE); Anton Oskari ENQVIST, Espoo (FI)

(21) Appl. No.: 16/614,579

(22) PCT Filed: May 18, 2017
(86) PCT No.: PCT/EP2017/061970

§ 371 Date: Nov. 18, 2019

(51) Int. Cl. H04W 36/00; H04B 7/15

(52) U.S. Cl. CPC H04W 36/0058; H04W 36/0009; H04B 7/15; H04W 36/0072; H04W 36/0061

(57) ABSTRACT

A mechanism for enhancing service continuity for a serving node is described. The mechanism comprising, for each user equipment being served by the serving node, sending a report comprising measurements of neighbouring cells of the user equipment to the serving node. Upon receiving each report, said serving node is configured to determine at least one target cell for the user equipment, wherein said target cell is indicated by two different target cell identities. Said serving node is further configured to receive a notification from a control unit, notifying the serving node to be switched off; send a request to a control node linked to the serving node, wherein said request comprising, for each user equipment being served by the serving node, at least one target cell identity associated with the user equipment, an identity of the user equipment and its UE contexts; and send a message to each user equipment being served by the serving node, wherein said message comprising at least one another target cell identity associated with respective user equipment.

### FIELD OF THE INVENTION

The present invention generally relates to next generation mobile and wireless communication systems, e.g. 5G systems. Specifically, the present invention relates to, but is not limited to, methods, apparatuses, system and computer program products for enhancing service continuity for serving nodes.

### BACKGROUND OF THE INVENTION

Mobile networks are experiencing avalanche of data traffic, with billions of wireless connected data-intensive devices using diverse multimedia services and applications.

Meanwhile, users expect the utmost in quality with seamless connectivity to broadband services. Under this context, moving networks, such as flexible network deployment based on nomadic nodes, emerge as a promising enhancement for 5G systems.

In response to increasing traffic volume and expectation of seamless connectivity being available everywhere, the concept of a nomadic network, which is defined as a network with randomly distributed nodes (e.g. parked vehicles with on-board relay infrastructure and advanced backhaul antennas) acting as potential relays between UEs and base stations (BS), has been proposed. While location of operator-deployed nodes or relay nodes is optimized by means of network planning, relay nodes in a nomadic network are randomly distributed. Moreover, their availability and position may change at any time, hence the term “nomadic”. Nomadic relay nodes operate in a self-organized fashion and are activated and deactivated based on criteria such as capacity, coverage, load balancing, energy efficiency, and etc. or any combination thereof, which reveals one fundamental feature of nomadic nodes in contrast to fixed access nodes. Namely, a nomadic node is associated with some uncertainty with regards to its availability, in other words, it may or may not be available in a target service region.

FIG. 1 depicts an example of a nomadic network. A nomadic relay node, is called a Crowd Box for instance, may be dynamically arranged by a nomadic relay node controller. The controller may communicate with the relay node via NMS/EMS. The information exchanged between a relay node and its controller may include location information, current transmit power, downlink and uplink centre frequency, band information, operating frequency, and etc. The interface via NMS/EMS is a conventional northbound interface, providing access to configuration management data, performance management data, and many other measurement counters. An eNB (e.g. eNB A101) wirelessly connected or linked to a relay node (e.g. A102) is often called a Donor eNB or D-eNB. In other words, a relay node is also controlled by its D-eNB.

FIG. 2 shows a relay node, serving both as a nomadic eNB and as a UE for wireless backhaul within a mobile network. Namely, a relay node has two roles. It acts as a UE from eNB A201 point of view, but servers as an eNB for UE A202. The relay node may be configured dynamically by a controller (not shown in FIG. 2), e.g. by a relay node controller being part of the management system (NMS/EMS) as explained previously. The relay node controller will provide dynamic adjustments of radio parameters for the relay node to achieve gains in coverage, capacity, and quality. The controller will also support the dynamic adjustment of transmit power level and dynamic turn on/off the embedded eNB within a relay node in order to optimize network performance.

As one exemplary example, nomadic relays may be realized by means of mounting relay nodes on cars. When a car is parked, a relay node may be activated for local and momentary network performance enhancements in terms of coverage enhancements for instance, such that UEs in urban scenarios suffering from macro propagation shadowing can be served too. Typically, such a car-hosted nomadic relay is only activated when the car is parked and some additional conditions like battery status are fulfilled, and it is de-activated when the car starts moving or due to other reasons, e.g. the battery is low and etc. With activation of a nomadic relay, UEs experiencing weak signals may be handed over to the new cell provided by, for example, the relay node operating on a different frequency carrier by means of inter-frequency handover.

While activation and additional affiliation of the UEs is rather straightforward, the problem arises with de-activation of nomadic relays, especially accompanied with starting and driving off of the car, which is not predictable from an eNB point of view. Usually starting a car requires full battery power, therefore a relay node mounted on the car has to be de-activated. Such a sudden switch-off of a nomadic relay node precludes a planned and properly carried out handover to an alternative nomadic relay or to the underlying macro cell, thus the active UEs being served by the relay node will experience a radio link failure and a service interruption, which should be avoided.

Switching off cells due to, for example, energy saving or re-claiming of spectrum in LSA operation is triggered by the network itself. Therefore, the network will control evacuation of the active users by handover to overlaying cells. This is not possible with nomadic relays, especially when switching-off a relay node is a random event, unpredictable from network perspective.

### SUMMARY OF THE INVENTION

The present invention and its embodiments seek to address at least part of the above-described issues and/or problems and drawbacks.

According to an exemplary aspect of the invention, there is provided a method for a serving node comprising receiving a report from a user equipment, wherein said report comprising measurements of neighbouring cells of the user equipment; determining at least one target cell for the user equipment upon receiving the report, wherein said target cell is indicated by two different target cell identities; receiving a notification from a control unit, notifying the serving node to be switched off; sending a request to a control node linked to the serving node, wherein said request comprising, for each user equipment being served by the serving node, at least one target cell identity associated with the user equipment, an identity of the user equipment and its UE contexts; and sending a message to each user equipment being served by the serving node, wherein said message comprising at least one another target cell identity associated with respective user equipment.

According to further development of the invention, said request further comprising an indication, indicating that the serving node will be switched off; said message further comprising a notification, informing the user equipment to connect to the target cell indicated by the another target cell identity.

According to further development of the invention, said target cell identity is in the form of cell global identity and said another target cell identity comprises physical cell identity and carrier frequency of the target cell.

According to further development of the invention, for each user equipment being served by the serving node, the latest target cell determined for the user equipment replaces the previous target cell determined for the user equipment.

According to a further exemplary aspect of the invention, there is provided method for a user equipment comprising sending a report comprising measurements of neighbouring cells of the user equipment to a serving node; receiving a notification from the serving node, notifying the user equipment that the serving node will be switched off, wherein said notification further comprising at least one target cell identity and an indication for the user equipment to connect to a target cell indicated by the target cell identity; attaching to the target cell; sending a re-establishment request to a node providing the target cell; establishing a radio link to the node upon receiving an acknowledgement from the node.

According to further development of the invention, the report is sent periodically and/or in the event the measurements of neighbouring cells is different from the last measurements.

According to further development of the invention, the target cell identity received by the user equipment comprising physical cell identity and carrier frequency of the target cell.

According to a further exemplary aspect of the invention, there is provided a method for a control node comprising receiving a message from a serving node linked to the control node, wherein said message comprising, for each user equipment being served by the serving node, at least one target cell identity associated with the user equipment, an identity of the user equipment and its UE contexts; determining, based on the target cell identity associated with the each user equipment, an entity providing a target cell indicated by the target cell identity.

According to further improvement of the invention, the method for the control node further comprising sending a request to the entity providing the target cell in the event the entity is not the control node, wherein said request comprising at least one target cell identity, a UE identity and UE contexts associated with the user equipment, for which the target cell is determined.

According to further improvement of the invention, said request further comprising an indication to the entity that re-establishment a connection with the user equipment should be prepared.

According to various embodiments of the invention, the entity providing the target cell may be a relay node linked to the control node, another control node, or a relay node linked to another control node.

According to further modification of the invention, the entity providing the target cell is the control node, said method for the control node further comprising preparing the target cell for re-establishing a connection to the user equipment, receiving a request for re-establishment the connection from the user equipment, and sending an acknowledgement to the user equipment.

According to a further exemplary aspect of the invention, there is provided a serving node comprising at least one processor, at least one memory comprisinging computer program code, and at least one interface configured for communication with at least another apparatus, the at least one processor, with the at least one memory and the computer program code, being configured to cause the apparatus to perform: receiving a report from a user equipment, wherein said report comprising measurements of neighbouring cells of the user equipment; determining at least one target cell for the user equipment upon receiving the report, wherein said target cell is indicated by two different target cell identities; receiving a notification from a control unit, notifying the serving node to be switched off; sending a request to a control node linked to the serving node, wherein said request comprising, for each user equipment being served by the serving node, at least one target cell identity associated with the user equipment, an identity of the user equipment and its UE contexts; and sending a message to each user equipment being served by the serving node, wherein said message comprising at least one another target cell identity associated with respective user equipment.

According to a further exemplary aspect of the invention, there is provided a user equipment comprising at least one processor, at least one memory comprising computer program code, and at least one interface configured for communication with at least another apparatus, the at least one processor, with the at least one memory and the computer program code, being configured to cause the apparatus to perform: sending a report comprising measurements of neighbouring cells of the user equipment to a serving node; receiving a notification from the serving node, notifying the user equipment that the serving node will be switched off, wherein said notification further comprising at least one target cell identity and an indication for the user equipment to connect to a target cell indicated by the target cell identity; attaching to the target cell; sending a re-establishment request to a node providing the target cell; establishing a radio link to the node upon receiving an acknowledgement from the node.

According to a further exemplary aspect of the invention, there is provided a control node comprising at least one processor, at least one memory comprisinging computer program code, and at least one interface configured for communication with at least another apparatus, the at least one processor, with the at least one memory and the computer program code, being configured to cause the apparatus to perform: receiving a message from a serving node linked to the control node, wherein said message comprising, for each user equipment being served by the serving node, at least one target cell identity associated with the user equipment, an identity of the user equipment and its UE contexts; determining, based on the target cell identity associated with the each user equipment, an entity providing a target cell indicated by the target cell identity.

According to a further exemplary aspect of the invention, there is provided a computer program comprising instructions which, when program is executed by a computer (e.g. a computer of an apparatus according to any one of the aforementioned apparatus-related exemplary aspects of the invention), cause the computer to carry out the method according to any one of the aforementioned method-related exemplary aspects of the invention.

Such computer program product may comprise (or be embodied) a (tangible) computer-readable (storage) medium or the like on which the computer-executable computer program code is stored, and/or the program may be directly loadable into an internal memory of the computer or a processor thereof.

### BRIEF DESCRIPTION OF THE DRAWINGS

Exemplary embodiments of the invention are described below, by way of example only, with reference to the following numbered drawings.

FIG. 1 shows a nomadic network.

FIG. 2 illustrates a relay node and its interfaces.

FIG. 3 depicts a signalling diagram when a connection is re-established to a cell served by the same eNB according to certain embodiment of the invention.

FIG. 4 depicts a signalling diagram when a connection is re-established to a cell served by a different eNB according to certain embodiment of the invention.

FIG. 5 depicts a signalling diagram when a connection is re-established to a cell provided by a relay node linked to the same eNB according to certain embodiment of the invention.

FIG. 6 depicts a signalling diagram when a connection is re-established to a cell provided by a relay node linked to a different eNB according to certain embodiment of the invention.

FIG. 7 illustrates a schematic diagram of a procedure performed by a node according to exemplary embodiments of the invention.

FIG. 8 illustrates a schematic diagram of a procedure performed by a UE according to exemplary embodiments of the invention.

FIG. 9 illustrates schematic diagram of a procedure performed by a control node according to exemplary embodiments of the invention.

FIG. 10 shows a block diagram illustrating an apparatus according to exemplary embodiments of the invention.

FIG. 11 shows a block diagram illustrating an UE according to exemplary embodiments of the invention.

FIG. 12 shows a block diagram illustrating a control apparatus according to exemplary embodiments of the invention.

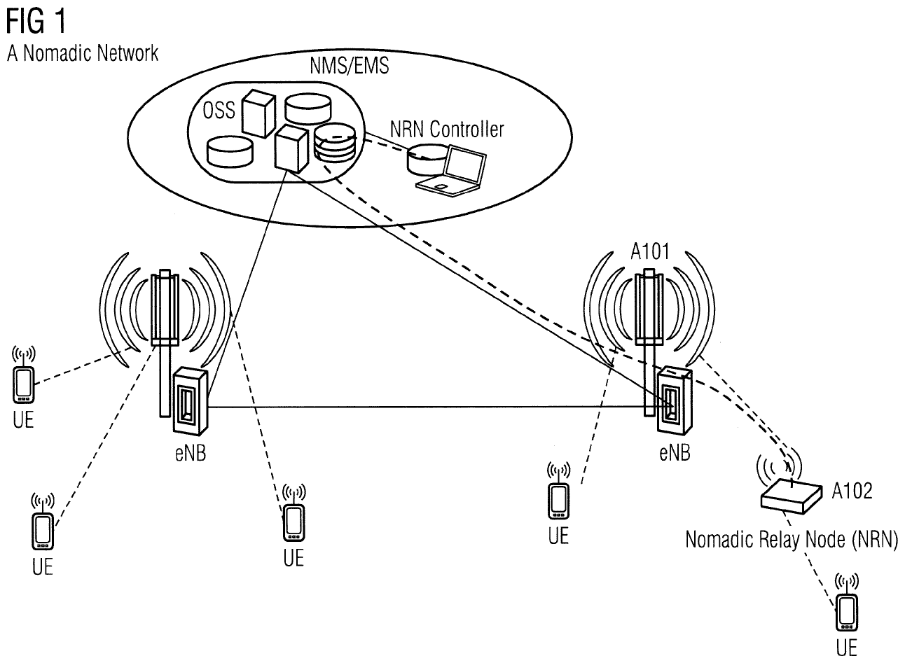

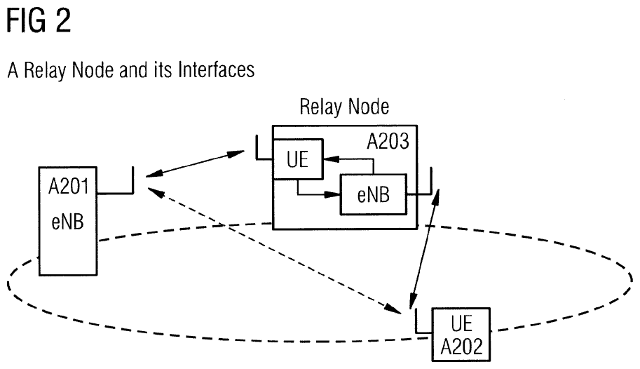

### DESCRIPTION OF THE EMBODIMENTS OF THE INVENTION

In order to ensure service continuity of the users being serving by suddenly turned-off relay node, a general method is proposed.
a) A nomadic relay node is informed of a status change which may lead to turning off the relay node. For example, if the nomadic relay node is mounted on a car, it may be connected with a car control unit (CCU) and get status information updated (i.e. changing status from static to moving) when the engine is going to be started, door is opened, driver seat is sat or any other feasible indications. Status change may also be triggered because of low battery of the car.
b) The status change information from the car control unit triggers several activities of the relay node in terms of initiating successful handovers of the UEs with active connection, or at least taking precautions for (fast) re-establishment for the case where transition time is too short for proper handover.

Ideally, this sort of rescue activity should start already before the car engine is started, e.g. indicated by unlocked doors or using sensors to identify whether the driver seat is sat. If the CCU can identify an event, which may uniquely indicate engine start several seconds in advance, the time should be sufficient for handing over the active UEs or at least preparing a safe re-establishment for them, hence preventing the UEs from call/connection loss.

According to one aspect of the invention, an interface between the CCU and the nomadic relay node within the car may be established. The relay node may be alerted via the interface in case of a status change which may lead to switching off the relay node. The car control unit is merely used as an example. It would be obvious for a skilled person in the art to extend the idea to other situation where an interface is required between a nomadic relay node and a control unit which may foresee the switching-off of the relay node.

Since it is unpredictable when the car will move and, as the result, the relay node has to be switched off; the relay node needs sufficient time to off-load before it is turned off. In order to make this time as short as possible, it would be beneficial if the relay node is aware of UE measurements in real time. Therefore, all UEs connected with a nomadic relay node may provide periodic reports to the relay node, which may be in several seconds' cycles. Alternatively, the UEs may do periodic measurements, but only report to the nomadic relay node if measurements are different from the previous measurements. Thus, UE battery may be saved.

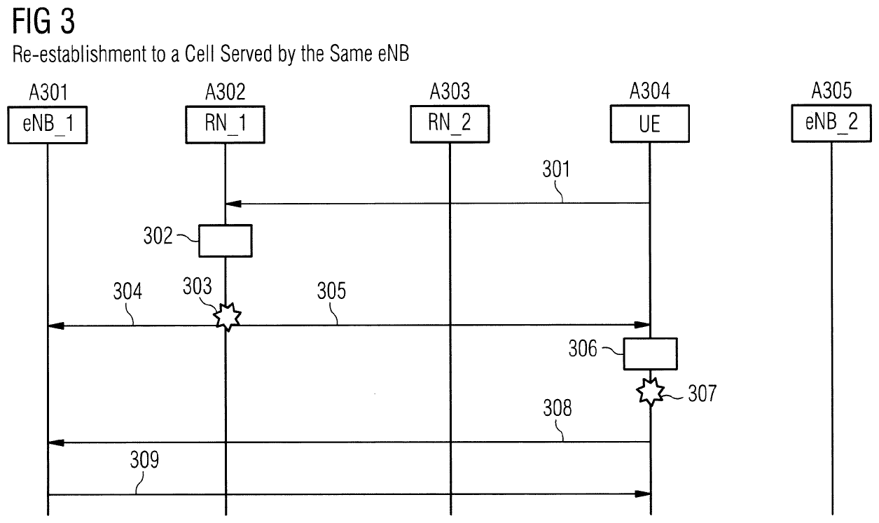

FIG. 3 shows another aspect of the invention when a UE tries to re-establish a connection to a cell served by the same eNB that also acts a D-eNB for the relay node to be switched off.

RN_1 A302 is a relay node connected/linked to its D-eNB, e.g. eNB_1 A301. In other words, RN_1 A302 is also controlled by eNB_1 A301. As stated previously, all the UE (e.g. UE A304) served by a relay node, e.g. RN_1 A302, may report the measurements of their neighbouring cells to the relay node, either periodically/regularly and/or when measurements are different from the previous measurements, as indicated in 301. The measurements may comprise, for instance, PCI, ARFCN, RSRP or/and RSRQ, etc. Upon receiving each report, RN_1 A302 may conclude, based on the received measurements, at least one target cell for each UE, indicated by a target cell identity (cell global identity, for instance), as depicted in 302. The latest target cell(s) determined for a user equipment may replace the previous target cell(s) determined for the user equipment. Whenever RN_1 A302 receives an indication 303 from a corresponding control unit (e.g. CCU, not shown in the figure) that it will be turned off, it may send a message 304 to its D-eNB, e.g. eNB_1 A301 and informing the D-eNB that it will be turned off. The message 304 may comprise at least one target cell identity associated with each UE and UE contexts of each UE stored at the RN_1 A302. The UE contexts may contain information regarding roaming and access restrictions which were provided either at connection establishment or the last TA update. As RN_1 A302 may serve more than one UE at the same time, the message may also include an identity for each UE so that a UE identity is associated its UE contexts and the relevant target cell identity/identities. The message 304 may be a detach request with the type field being e.g. “switch off”.

Simultaneously, RN_1 A302 may send another message 305 to each UE under its service, e.g. UE A304. The message may comprise another target cell identity associated with the target cell specifically determined for respective UE. The target cell identity in the message 305 may comprise, e.g. PCI and carrier frequency of the target cell, e.g. ARFCN, according to certain embodiment of the invention. The message 305 may notify the UE(s) that the serving node, e.g. RN_1 A302, may be switched off soon and each UE to be affected may re-establish its connection towards its target cell indicated by the received target cell identity.

In 306, each UE (e.g. UE A304) may attach to its target cell, indicated by the received target cell identity. Namely, UE A304 may search for its target cell indicated by PCI and the carrier frequency and may get synchronized with the target cell in downlink. When the UE A304 is attached to the target cell, it may also get synchronized in uplink with the target cell via RACH. Then the UE A304 may send a re-establishment request to an entity (e.g. eNB_1 A301) providing the target cell, as shown in 308. The request 308 may be sent via radio link. As the serving node RN_1 A302 is about to be turned off, the radio link failure 307 for all the UEs under its service could happen at any time. It is expected that each UE to be affected should work in each target cell as soon as possible in order to avoid connection loss. Thus, a connection re-establishment request message with a new cause, e.g. relay deactivated, may be used so as to bypass authentication/authorization procedure required for a normal connection setup procedure (e.g. a re-connection request).

According to one embodiment of the invention, the target cell for UE A304 may be served/provided by the same eNB (e.g. eNB_1 A301) which is connected to the serving node (e.g. RN_1 A302) to be switched off. eNB_1 A301 may realize, based on the received target cell identity that the target cell for the UE A304 is provided by itself. It may prepare the target cell for re-establishing a connection with UE A304. eNB_1 A301 may reserve resources, e.g. radio bearer context, and create a data structure for storing the UE contexts of UE A304, which is received from RN_1 A302. The UE contexts may facilitate identifying the UE when it tries to access the target cell using RACH. The connection may be established when eNB_1 A301 acknowledges, as indicated in 309, the re-establishment request from UE A304.

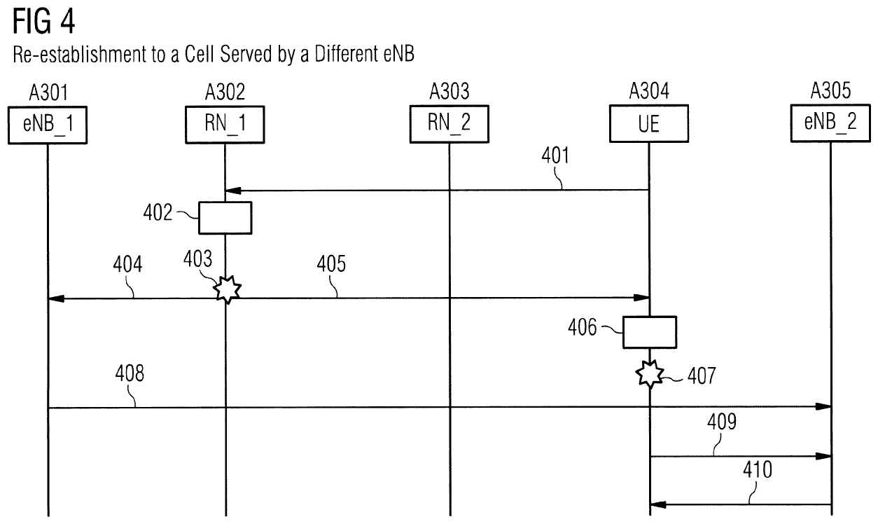

FIG. 4 shows a third aspect of the invention when a UE tries to re-establish a connection to a cell served by an eNB being different from the one connected to the serving node to be switched off.

The steps 401 to 407 in FIG. 4 are similar to the corresponding steps 301 to 307 in FIG. 3. In this example, however, the target cell for a UE (e.g. UE A304) may be provided by another eNB (e.g. eNB_2 A305), being different from the eNB (e.g. eNB_1 A301) controlling the serving node RN_1 A302. From a target cell identity, it is possible to derive an identity of the entity (e.g. eNB or a relay node) providing the cell of such cell identity. Thus, the eNB_1 A301 may derive an identity of the entity (e.g. eNB_2 A305) providing the target cell based on the received target cell identity. eNB_1 A301 may conclude from the derived identity that the target cell is not provided by itself. Then, eNB_1 A301 may send a message 408 to the entity which can be sufficiently identified by its identity. The message 408, may be in a form of a handover request, may comprise an identity of UE A304 which will be affected by the radio link failure 407, at least one target cell identity associated with UE A304, UE context of UE A304 and an indication that no handover but re-establishment should be prepared.

In a typical handover procedure, it is expected that a target entity shall provide an acknowledgement to a source entity as a part of preparation procedure. The acknowledgement is also conveyed to the concerned UE so as to trigger the handover. However, as the source entity, i.e. RN_1 A302, is about to be switched off at any time, there is a high probability that the acknowledgement will not reach the source entity RN_1 A302. So the handover procedure is not reliable. Just as explained in the accompanying texts for FIG. 3, connection re-establishment is preferred so as to bypass authentication/authorization procedure required for a normal connection setup procedure.

Similar to 308 in FIG. 3, UE A304 may send a re-establishment request 409, via radio link, to the entity, e.g. eNB_2 A305, providing its target cell. The request may be a connection re-establishment request with a new cause, e.g. relay deactivated. UE A304 may receive an acknowledgement to the request, as indicated in 410, when a connection between UE A304 and eNB_2 A305 is established.

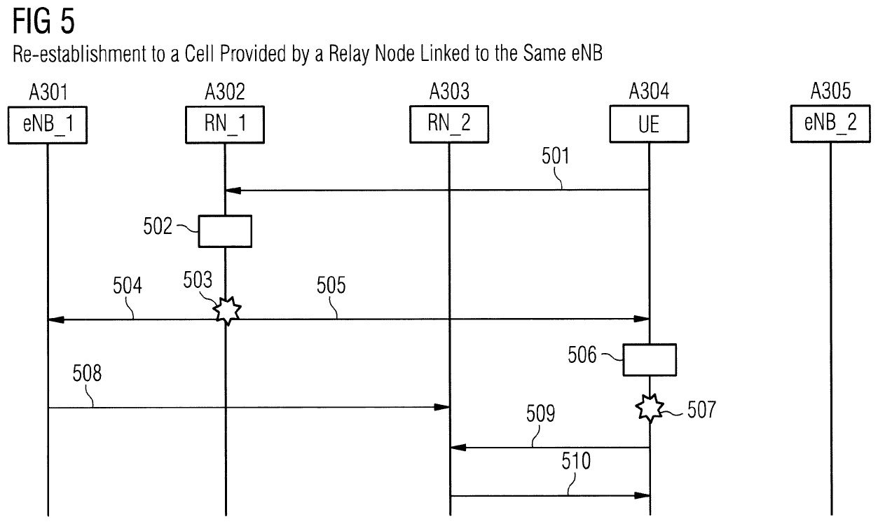

FIG. 5 shows a fourth aspect of the invention when a UE tries to re-establish a connection to a cell served by another relay node linked to the same eNB. In this example, both the relay nodes RN_1 A302 and RN_2 A303 are linked to and also controlled by eNB_1 A301. But, RN_1 A302 may be switched off soon upon receiving a notification 503 from a corresponding control unit, e.g. CCU (not shown in the figure).

The steps 501 to 507 in FIG. 5 are similar to the corresponding steps 301 to 307 in FIG. 3. In this example, however, the target cell for a UE (e.g. UE A304) may be provided by another relay node, e.g. RN_2 A303, according to an embodiment of the invention.

As explained previously, the eNB_1 A301 may derive an identity of the entity (e.g. RN_2 A303) providing the target cell, based on the received target cell identity in 504, and send a message 508 to the entity. The message, may be in a form of a handover request, may comprise an identity of UE A304, at least one target cell identity associated with UE A304, UE context of UE A304 and an indication that no handover but re-establishment should be prepared. Just as explained previously, the handover procedure is not reliable due to the switching-off the source entity RN_1 A302.

Similar to 409 in FIG. 4, UE A304 may send a re-establishment request 509 to the entity providing the target cell, e.g. RN_2 A303. UE A304 may receive an acknowledgement from RN_2 A303 when a connection between UE A304 and RN_2 A303 is established, as indicated in 510.

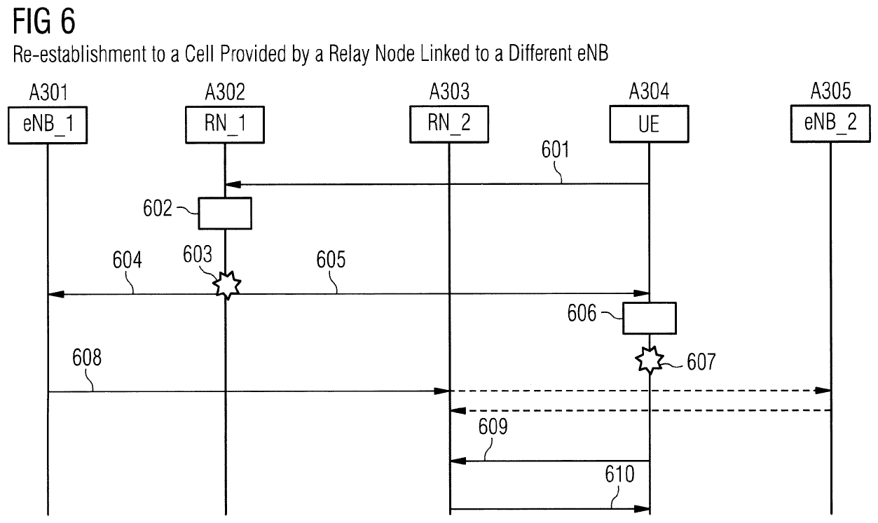

FIG. 6 shows a fifth aspect of the invention when a UE tries to re-establish a connection to a cell served by another relay node linked to another eNB, being different from the eNB linked to the relay node to be switched off.

The steps 601 to 607 in FIG. 6 are similar to the corresponding steps 301 to 307 in FIG. 3. In this example, however, RN_1 A302 is connected to eNB_1 A301 and RN_2 A303 is connected to eNB_2 A305. The target cell for a UE (e.g. UE A304) may be provided by RN_2 A303.

As explained previously, eNB_1 A301 may derive an identity of the entity providing the target cell, e.g. RN_2 A303, based on received target cell identity in 604 and send a message 608 to the entity. The message 608, may be in a form of a handover request, may comprise an identity of UE A304, at least one target cell identity associated with UE A304, the UE context of UE A304 and an indication that no handover but re-establishment should be prepared. Just as explained previously, the handover procedure is not reliable due to the switching-off the source entity RN_1 A302. The message 608 may be routed to RN_2 A303 via its D-eNB, i.e. eNB_2 A305, as indicated by the dotted lines. Similar to 509 in FIG. 5, UE A304 may send a re-establishment request 609 to the entity providing the target cell, e.g. RN_2 A303. UE A304 may receive an acknowledgement from RN_2 A303 when a connection between UE A304 and RN_2 A303 is established as indicated in 610.

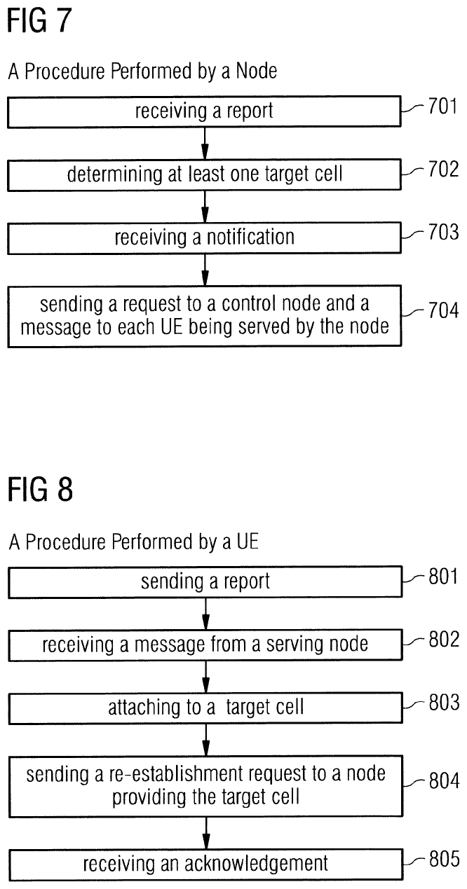

FIG. 7 shows a procedure may be performed by a node, for example a relay node RN_1 A302, according to a sixth aspect of the invention.

As explained in the foregoing FIGS. 4-6, a serving node, e.g. RN_1 A302, may receive reports from each UE under its service, e.g. UE A304, as indicated in 701. The report may comprise measurements of neighbouring cells of UE A304, for instance, PCI, ARFCN, RSRP or/and RSRQ, etc. Based on each received report, RN_1 A302 may determine, for the relevant UE, at least one target cell (e.g. based on the cell of the strongest signal indicated by RSRP), which may be indicated by a target cell identity, e.g. cell global identity, in 702. The latest target cell identities may overwrite the previous target cell identities in case they are different. RN_1 A302 may receive a notification from a corresponding control unit (e.g. CCU) that it will be turned off, as depicted in 703. Immediately after that, RN_1 A302 may send a message to each UE under its service, e.g. UE A304, in 704. The message may comprise a target cell identity associated with the determined target cell for UE A304. The cell identity may comprise, e.g. PCI, and carrier frequency of the target cell, e.g. indicated by ARFCN. In addition, the message may notify UE A304 that its serving node RN_1 A302 may be switched off soon and it may re-establish its connection towards the target cell indicated by the target cell identity.

Simultaneously, RN_1 A302 may also send a request in 704 to a control node (e.g. eNB_1 A301). The request may comprise, for each UE currently being served by RN_1 A302, a UE identity, UE contexts and at least one target cell identity associated with the UE. The target cell identity in the request may be in the form of global cell identity. The UE context of each UE currently being served by RN_1 A302 is stored at the RN_1 A302. The UE contexts may contain information regarding roaming and access restrictions which were provided either at connection establishment or the last TA update. The request may also inform eNB_1 A301 that RN_1 A302 will be turned off soon. The request may be a detach request with the type field being e.g. “switch off”.

FIG. 8 shows a procedure maybe performed by a UE, for example UE A304, according to a seventh aspect of the invention.

In 801, a UE (e.g. UE A304) may report the measurements of its neighbouring cells to its serving node, e.g. RN_1 A302, either periodically/regularly and/or when measurements are different from the previous measurements. The measurements may comprise, for instance, PCI, ARFCN, RSRP or/and RSRQ, etc. As depicted in 802, the UE may receive a message comprising at least one target cell identity from its serving node RN_1 A302. The target cell identity may comprise e.g. PCI and carrier frequency of the target cell, e.g. ARFCN. The message may also notify the UE that its serving node may be switched off soon and the UE may re-establish its connection towards the target cell indicated by the received target cell identity. UE A304 may search for the target cell indicated by PCI and the carrier frequency and may get synchronized with the target cell in downlink. When UE A304 attaches to the target cell in 803, it may also get synchronized with the target cell in uplink via RACH. Then, UE A304 may send a re-establishment request to an entity providing the target cell as shown in 804. The request may be sent via radio link, for instance. As the serving node, e.g. RN_1 A302, is about to be turned off at any time, it is expected that each UE concerned (e.g. UE A304) should work in its target cell as soon as possible in order to avoid connection loss. Thus, re-establishment request is preferred so as to bypass authentication/authorization procedure required for a normal connection setup procedure (e.g. a re-connection request). A new connection may be established between UE A304 and the entity providing its target cell upon receiving an acknowledgement as shown in 805.

According to certain embodiments of the invention, the entity providing the target cell may be the same eNB (e.g. eNB_1 A301) linked to RN_1 A302 which is about to be switched off. According to another embodiment of the invention, the entity providing the target cell may be another eNB (e.g. eNB_2 A305), being different from the one linked to the RN_1 A302. According to a third embodiment of the invention, the entity providing the target cell may be a relay node (e.g. RN_2 A303) linked to another eNB (e.g. eNB_2 A305), being different from the eNB linked to RN_1 A302.

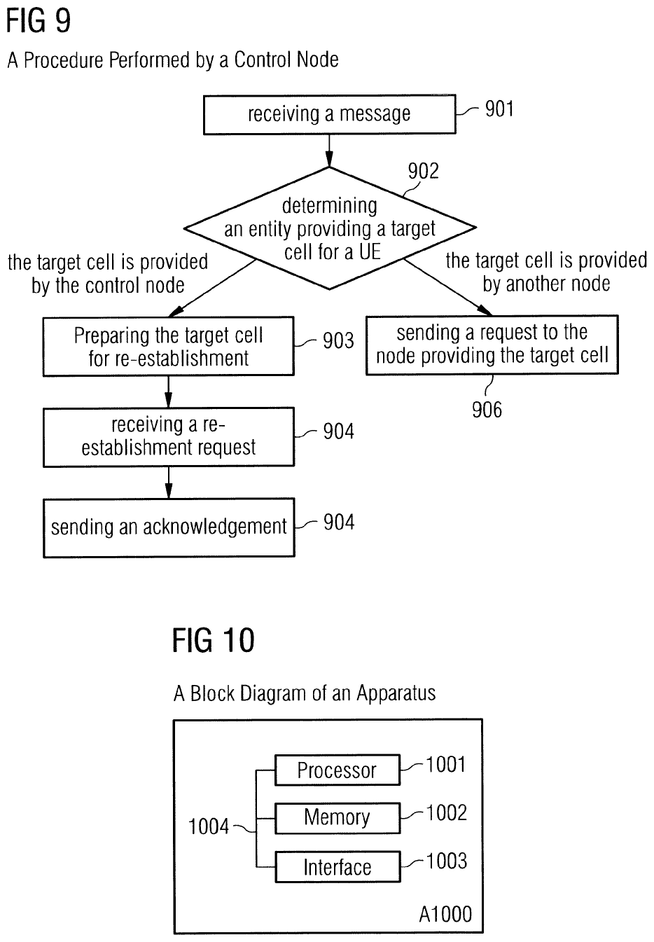

FIG. 9 shows a procedure maybe performed by a control node, according to an eighth aspect of the invention.

In 901, a control node, for example eNB_1 A301, may receive a message from a node (e.g. RN_1 A302) under its control. The message may indicate that the node is about to be switched off. The message may comprise, for each UE (e.g. UE A304) being served by the node to be switched off, a UE identity, UE contexts and at least one target cell identity associated with the UE. The UE context of each UE currently being served by RN_1 A302 is stored at RN_1 A302. The UE contexts may contain information regarding roaming and access restrictions which were provided either at connection establishment or the last TA update. The target cell identity may be in the form of a global cell identity. In 902, the control node may determine the entity providing a target cell based on the received target cell identity, e.g. by deriving an identity of the entity providing the target cell. If it is determined from the derived identity that the target cell is provided by the control node, it may prepare the target cell for re-establishing a connection towards the relevant UE in 903. In other words, the control node may reserve resources, e.g. radio bearer context, and create a data structure for storing the relevant UE contexts, which may facilitate identifying the UE when it tries to access the target cell using RACH. In 904, the control node may receive a request for re-establishment from the relevant user equipment, e.g. UE A304, which may intend to access the target cell. The control node may send an acknowledgement to UE 304 in 905 when a connection between the UE and the control node is established.

If it is determined that the target cell is provided by another entity, the control node may send a request to the entity providing the target cell, based on the derived identity of the entity as depicted in 906. The request, may be in a form of a handover request, may comprise at least one target cell identity, a UE identity and UE context associated with the relevant UE (e.g. UE A304), for which the target cell is determined, and an indication that no handover but re-establishment should be prepared for the UE. As described in FIGS. 4-6 and the accompanying texts, according to different embodiments of the invention, the entity providing the target cell may be another relay node (e.g. RN_2 A303) linked to the control node; another control node (e.g. eNB_2 A305) or its relay node.

According to one exemplary embodiment of the invention, a serving node (e.g. RN_1 A302) may be serving 3 UEs, i.e. UE1, UE2 and UE3. Each UE has an identity, i.e. UE_ID1, UE_ID2 and UE_ID3. Based on respective report sent by the three UEs, Cell1, Cell2 and Cell3, indicated by target cell identities C_ID1, C_ID2 and C_ID3, have been determined as the target cells for the three UEs respectively.

The serving node may determine more than one target cell for a UE and the target cells for a particular UE may be indicated by target cell identities with preference, e.g. the most preferred target cell for the UE is indicated by the first target cell identity in a message. For instance, Cell1a, Cell1b and Cell1c, indicated by target cell identities C_ID1a, C_ID1b and C_ID1c respectively, may be determined as the target cells for UE1. Cell1a would be the most preferred target cell if C_ID1a is placed as the first target cell identity in a message and Cell1c would be the least preferred target cell if C_ID1c is placed as the last target cell identity in the message. For the sake of simplicity, only one target cell is determined per UE in this example.

Cell1, Cell2 and Cell3, may also be indicated by other target cell identities, e.g. Cell_ID1, Cell_ID2 and Cell_ID3, being different from target cell identities C_ID1, C_ID2 and C_ID3, although they refer to the same target cells respectively.

When the serving node is notified that it will be switched off soon, it may send a request to its control node (e.g. eNB_1 A301). The request may comprise parameters such as {(UE_ID1, C_ID1, UE1 contexts), (UE_ID2, C_ID2, UE2 contexts), (UE_ID3, C_ID3, UE3 contexts)} and an indication that the serving node will be turned off.

Simultaneously, the serving node may send a message to UE1 comprising Cell_ID1, the target cell identity of Cell1. Likewise, the serving node may send a message to UE2 comprising Cell_ID2, and a message to UE3 comprising Cell_ID3.

Upon receiving the request, the control node eNB_1 A301 may determine, based on the received cell identities, the entities providing the target cells. Assuming Cell1 is provided by eNB_1 A301, Cell2 is provided by RN_2 A303, another relay node linked to eNB_1 A301, and Cell3 is provided by eNB_2 A305.

For UE1, eNB_1 A301 may prepare Cell1 for re-establishing a connection with UE1. It may reserve resources, e.g. radio bearer context, and create a data structure for storing UE1 contexts, which may facilitate identifying UE1 when it tries to access Cell1 using RACH. UE1 may send a re-establishment request to eNB_1 A301 and receive an acknowledgement therefrom.

For UE2, eNB_1 A301 may send a request for re-establishment comprising (UE_ID2, C_ID2, UE2 contexts) to RN_2 A303.

For UE3, eNB_1 A301 may send a request for re-establishment comprising (UE_ID3, C_ID3, UE3 contexts) to eNB_2 A305.

The rest of the procedures are similar to the relevant procedures described in FIG. 3-5.

FIG. 10 is a block diagram illustrating an apparatus according to an exemplary embodiment of the invention. An apparatus A1000 may be a node, for instance a relay node RN_1 A302.

According to one exemplary embodiment of the invention, the apparatus A1000 representing RN_1 A302 comprises at least one processor or processing means 1001, at least one memory 1002 including computer program code, and at least one interface 1003, which are connected by a bus 1004 or the like. The apparatus A1000 may serve one or more UEs, for instance UE A304. The processor (i.e. the at least one processor/processing means 1001, with the at least one memory 1002 and the computer program code) is configured to perform receiving a report from each UE being served by the node. The report may comprise measurements of neighbouring cells of the UE, for instance, PCI, ARFCN, RSRP or/and RSRQ, etc. The processor may be configured to perform determining at least one target cell for a relevant UE upon receiving each report. The latest target cell(s) determined for a UE may replace the previous target cell(s) determined for the UE. The processor may be configured to perform receiving a notification from a corresponding control unit indicating that the apparatus A1000 to be switched off soon. The processor may be further configured to perform sending a request to its control node and a message to each UE under its service right after receiving the notification.

The request may comprise, for each UE currently being served by the apparatus A1000, a UE identity, UE contexts and at least one target cell identity associated with the UE. The target cell identity may be in the form of a cell global identity. The request may also indicate to its control node that the apparatus A1000 will be turned off soon.

The message sent to each UE may comprise another target cell identity associated with respective UE. The target cell identity in the message may comprise, e.g. PCI and carrier frequency of the target cell, e.g. ARFCN. In addition, the message may notify each UE that apparatus A1000 may be switched off soon and each UE may re-establish its connection with its target cell indicated by respective target cell identity.

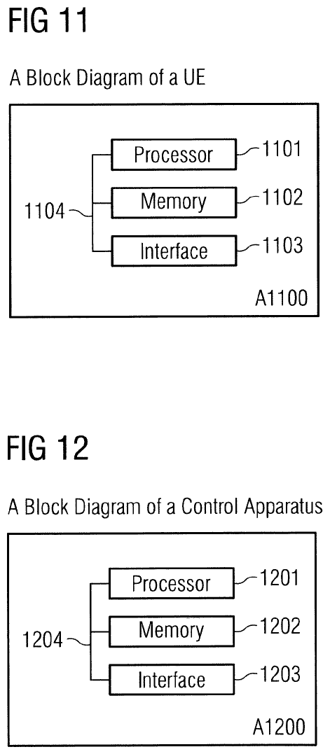

FIG. 11 is a block diagram illustrating an apparatus according to an exemplary embodiment of the invention. An apparatus A1100 may be a UE, for instance UE A304.

According to one exemplary embodiment of the invention, the apparatus A1100 representing UE A304 comprises at least one processor or processing means 1101, at least one memory 1102 including computer program code, and at least one interface 1103, which are connected by a bus 1104 or the like.

The processor (i.e. the at least one processor/processing means 1101, with the at least one memory 1102 and the computer program code) is configured to perform reporting the measurements of its neighbouring cells to a serving node, e.g. RN_1 A302, either periodically/regularly, e.g. in several seconds' cycles, and/or only when measurements are different from the previous measurements. The measurements may comprise, for instance, PCI, ARFCN, RSRP or/and RSRQ, etc. The processor is further configured to perform receiving a message comprising at least one target cell identity from the serving node. The target cell identity in the message may be indicated by e.g. PCI and carrier frequency of the target cell, e.g. ARFCN. The message also may notify the UE that its serving node may be switched off soon and the UE may re-establish its connection towards the target cell indicated by the received target cell identity. The processor is further configured to perform attaching to the target cell. The processor is further configured to perform sending a re-establishment request, e.g. via radio link, to an entity providing the target cell. The processor is further configured to perform receiving an acknowledgement from the entity providing the target cell. As explained in foregoing exemplary description (e.g. FIG. 8 and the accompanying texts), the target cell may be provided by different entities according to different arrangement of the invention.

FIG. 12 is a block diagram illustrating an apparatus according to an exemplary embodiment of the invention. An apparatus A1200 may be a control node, for instance eNB_1 A301.

According to one exemplary embodiment of the invention, the apparatus A1200 representing eNB_1 A301 comprises at least one processor or processing means 1201, at least one memory 1202 including computer program code, and at least one interface 1203, which are connected by a bus 1204 or the like.

The processor (i.e. the at least one processor/processing means 1201, with the at least one memory 1202 and the computer program code) is configured to perform receiving a message from a node (e.g. RN_1 A302) which is controlled by the apparatus A1200. The message may indicate that the node is about to be switched off and may comprise, for each UE (e.g. UE A304) currently being served by the node, a UE identity, its UE contexts and at least one target cell identity associated with the UE. The UE contexts may contain information regarding roaming and access restrictions which were provided either at connection establishment or the last TA update. The target cell identity may be in the form of cell global identity. The processor is further configured to perform determining the entity providing the target cell based on the received target cell identity. If it is determined from the derived identity that a target cell is provided by the apparatus A1200, the processor is further configured to perform preparing the target cell for re-establishing a connection with a relevant UE. The processor is further configured to perform receiving a request for re-establishment from the UE which intends to access the target cell, and sending an acknowledgement to the UE when a connection between the UE and the apparatus A1200 is established.

If it is determined that the target cell is provided by another entity, the processor is further configured to perform sending a request to the entity providing the target cell. The request may comprise at least one target cell identity, a UE identity, UE context associated with the relevant UE, for which the target cell is determined, and an indication that no handover but re-establishment should be prepared for the UE. The target cell identity may be in the form of cell global identity. As described in foregoing FIGS. 4-6 and the accompanying texts, different entities may provide the target cell.

In the foregoing exemplary description of the apparatuses, only the units that are relevant for understanding the principles of the invention have been described using functional blocks. Each apparatus may comprise further units that are necessary for its respective operation. However, a description of these units is omitted in this specification for the sake of clarity and simplicity. Moreover, the arrangement of the functional blocks of the apparatuses is not construed to limit the invention, and the functions may be performed by one block or further split into sub-blocks.

When it is stated in the foregoing description that the apparatus (or some other means) is configured to perform certain function, this is to be construed to be equivalent to a description stating that a (i.e. at least one) processor/corresponding circuitry/processing means, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function.

The processor 1001/1101/1201 and/or the interface 1003/1103/1203 may also include a modem or the like to facilitate communication over a (hardwire or wireless) link, respectively. The interface 1003/1103/1203 may include a suitable transceiver coupled to one or more antennas or communication means for (hardwire or wireless) communications with the linked or connected device(s), respectively. The interface 1003/1103/1203 is generally configured to communicate with at least one other apparatus, i.e. the interface thereof. Although not explicitly stated in the foregoing description, receiving/sending messages/requests/reports/acknowledgements may be performed via or through the interface 1003/1103/1203 of each apparatus concerned.

The memory 1002/1102/1202 may store respective programs assumed to include program instructions or computer program code that, when executed by the respective processor, enables the respective apparatus to operate in accordance with the exemplary embodiments of the present invention.

In general terms, the respective apparatuses (and/or parts thereof) may represent means for performing respective operations and/or exhibiting respective functionalities, and/or may have functions for performing respective operations and/or exhibiting respective functionalities.

Apparatus, such as relay node, eNB and UE are merely used as examples in the foregoing description, but not to be construed as limiting the invention. Any suitable entity may also play the role of these apparatuses when the invention is put into practice by a skilled person in the art. For instance, a relay node may be a nomadic relay node. An eNB may be a suitable base station situated in a macro/micro/pico/femto site. A cell a UE is located at or a target cell determined for a UE may be a macro/micro/pico/femto cell.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention. In order to determine the metes and bounds of the invention, therefore, reference should be made to the appended claims.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

It is to be understood that the above description is illustrative of the invention and is not to be construed as limiting the invention. Various modifications, applications and/or combination of the embodiments may occur to those skilled in the art without departing from the scope of the invention as defined by the appended claims.

### Partial Glossary

ARFCN Absolute Radio Frequency Channel Number

eNB e Node B

EMS Element Management System

LSA Licensed Shared Access

MNS Network Management System

PCI Physical Cell Identity

RACH Random Access Channel

RN Relay Node

RSRP Reference Signal Received Power

RSRQ Reference Signal Received Quality

TA Tracking Area

UE User Equipment

1.-35. (canceled)

36. A method for a serving node, said method comprising:
receiving a report from a user equipment (UE), said report comprising measurements of neighbouring cells of the user equipment;
determining at least one target cell for the user equipment upon receiving the report, wherein said target cell is indicated by two different target cell identities;
receiving a notification from a control unit, notifying the serving node to be switched off;
sending a request to a control node linked to the serving node, said request comprising, for each user equipment being served by the serving node, at least one target cell identity associated with the user equipment, an identity of the user equipment and its UE contexts; and
sending a message to each user equipment being served by the serving node, said message comprising at least one another target cell identity associated with respective user equipment.

37. The method for a serving node according to claim 36, said request further comprising an indication, indicating that the serving node will be switched off.

38. The method for a serving node according to claim 36, said message further comprising a notification informing the user equipment to connect to the target cell indicated by the another target cell identity.

39. The method for a serving node according to claim 36, wherein said target cell identity comprises cell global identity and said another target cell identity comprises physical cell identity and carrier frequency of the target cell.

40. The method for a serving node according to claim 36, wherein, for each user equipment being served by the serving node, the latest target cell determined for the user equipment replaces the previous target cell determined for the user equipment.

41. The method for a serving node according to claim 36, wherein said serving node is a nomadic relay node.

42. A method for a user equipment, said method comprising:
sending a report comprising measurements of neighbouring cells of the user equipment (UE) to a serving node;
receiving a notification from the serving node, notifying the user equipment that the serving node will be switched off, said notification further comprising at least one target cell identity and an indication for the user equipment to connect to a target cell indicated by the target cell identity;
attaching to the target cell;
sending a re-establishment request to a node providing the target cell;
establishing a radio link to the node upon receiving an acknowledgement from the node.

43. The method for a user equipment according to claim 42, wherein the report is sent periodically or in the event the measurements of neighbouring cells is different from the last measurements; the target cell identity comprising physical cell identity and carrier frequency of the target cell.

44. A method for a control node, said method comprising:
receiving a message from a serving node linked to the control node, said message comprising, for each user equipment (UE) being served by the serving node, at least one target cell identity associated with the user equipment, an identity of the user equipment and its UE contexts;
determining, based on the target cell identity associated with the each user equipment, an entity providing a target cell indicated by the target cell identity.

45. The method for a control node according to claim 44, further comprising sending a request to the entity providing the target cell in the event the entity is not the control node, wherein said request comprising at least one target cell identity, a UE identity and UE contexts associated with the user equipment, for which said target cell is determined.

46. The method for a control node according to claim 45, wherein the entity providing the target cell is the control node, said method further comprising:
preparing the target cell for re-establishing a connection to the user equipment;
receiving a request for re-establishment the connection from the user equipment; and
sending an acknowledgement to the user equipment.

47. A serving node, comprising:
at least one processor,
at least one memory comprising computer program code, and
at least one interface configured for communication with at least another apparatus,
the at least one processor, with the at least one memory and the computer program code being configured to cause the apparatus to perform:
receiving a report from a user equipment (UE), said report comprising measurements of neighbouring cells of the user equipment;
determining at least one target cell for the user equipment upon receiving the report, wherein said target cell is indicated by two different target cell identities;
receiving a notification from a control unit, notifying the serving node to be switched off;
sending a request to a control node linked to the serving node, said request comprising, for each user equipment being served by the serving node, at least one target cell identity associated with the user equipment, an identity of the user equipment and its UE contexts; and
sending a message to each user equipment being served by the serving node, said message comprising at least one another target cell identity associated with respective user equipment.

48. The serving node according to claim 47, wherein said serving node is a nomadic relay node.

49. A user equipment, comprising:
at least one processor,
at least one memory comprising computer program code, and
at least one interface configured for communication with at least another apparatus,
the at least one processor, with the at least one memory and the computer program code, being configured to cause the apparatus to perform:
sending a report comprising measurements of neighbouring cells of the user equipment to a serving node;
receiving a notification from the serving node, notifying the user equipment that the serving node will be switched off, said notification further comprising at least one target cell identity and an indication for the user equipment to connect to a target cell indicated by the target cell identity;
attaching to the target cell;
sending a re-establishment request to a node providing the target cell;
establishing a radio link to the node upon receiving an acknowledgement from the node.

50. The user equipment according to claim 49, wherein the report is sent periodically or in the event the measurements of neighbouring cells is different from the last measurements, the target cell identity comprising physical cell identity and carrier frequency of the target cell.

51. A control node, comprising:
at least one processor,
at least one memory comprising computer program code, and
at least one interface configured for communication with at least another apparatus,
the at least one processor, with the at least one memory and the computer program code, being configured to cause the apparatus to perform:
receiving a message from a serving node linked to the control node, said message comprising, for each user equipment (UE) being served by the serving node, at least one target cell identity associated with the user equipment, an identity of the user equipment and its UE contexts;
determining, based on the target cell identity associated with the each user equipment, an entity providing a target cell indicated by the target cell identity.

52. The control node according to claim 51, further comprising:
sending a request to the entity providing the target cell in the event the entity is not the control node,
said request comprising at least one target cell identity, a UE identity and UE contexts associated with the user equipment, for which the target cell is determined;
said request further comprising an indication to the entity that re-establishment a connection with the user equipment should be prepared.

53. The control node according to claim 52, wherein the entity providing the target cell is the control node, said method further comprising:
preparing the target cell for re-establishing a connection to the user equipment;
receiving a request for re-establishment the connection from the user equipment; and
sending an acknowledgement to the user equipment.

54. A computer program embodied on a non-transitory computer-readable medium comprising instructions which, when program is executed by a computer, cause the computer to carry out the method according to claim 36.
